(19) United States
(12) Patent Application Publication
(10) Pub. No.: US 2012/0249757 A1
(43) Pub. Date: Oct. 4, 2012

(54) Stereoscopic Video Display Device

(75) Inventor: Nobutoshi Fujinami, Osaka (JP)

(73) Assignee: PANASONIC CORPORATION, Kadoma-shi, Osaka (JP)

(21) Appl. No.: 13/515,293

(22) PCT Filed: Feb. 10, 2011
(86) PCT No.: PCT/JP2011/000766

§ 371 Date: Jun. 12, 2012

(30) Foreign Application Priority Data
Feb. 15, 2010 (JP) 2010-029762

(51) Int. Cl. H04N 13/04

(52) U.S. Cl. 348/51; 348/E13.075

(57) ABSTRACT

An object is to provide a stereoscopic video display device having improved convenience which simultaneously displays a plurality of stereoscopic video footages on one screen, thereby allowing a viewer to simultaneously view the plurality of stereoscopic video footages. The stereoscopic video display device includes: a display panel 230 in which a screen for displaying a plurality of stereoscopic video footages is arranged; and a video control section 240 that controls the display of the plurality of stereoscopic video footages. Each stereoscopic video footage includes right-eye video and left-eye video each having parallax with respect to the other. The video control section 240 simultaneously displays the stereoscopic video footages in given positions on the screen, periodically displays the right-eye video and the left-eye video of each stereoscopic video footage, and synchronizes the timing at which the right-eye video and the left-eye video of each stereoscopic video footage are displayed.

### TECHNICAL FIELD

The present invention relates to stereoscopic video display devices that exploit parallax between the eyes to display stereoscopic video.

### BACKGROUND ART

The development of stereoscopic video display devices that use plasma display panels or liquid crystal panels to display stereoscopic video has been actively underway in recent years. Stereoscopic video display devices exploiting parallax between the eyes typically display, in alternation on a display-panel screen, right-eye video and left-eye video each having parallax with respect to the other. When the right-eye video is screened, the video is seen with the right eye, and when the left-eye video is screened, the video is seen with the left eye. Since these right-eye and left-eye video views have parallax between them, the video can be seen stereoscopically. With such stereoscopic video, the sense of depth and the sense of projection of the video change in response to the parallax between the right-eye video and the left-eye video. When the parallax is large, the depth and the projection also increase, and when the parallax is small, the depth and the projection also decrease.

In order to view the right-eye video with the right eye and the left-eye video with the left eye in a stereoscopic video display device of this sort, a shutter-type visor, for example, is used. In a shutter-type visor, liquid crystal filters that switch between passing and blocking light are arranged in the right-eye lens and the left-eye lens. Passage and blocking of light is switched by the opening and closing of the liquid-crystal-filter shutters.

Specifically, the timing at which the shutters in the liquid crystal filters are opened/closed, which are arranged in the right eye lens and the left eye lens, is switched in synchronization with the timing at which the right-eye video and the left-eye video that are displayed on the display panel are switched. In other words, in synchronization with the timing at which switching to the right-eye video is performed, the shutter in the liquid crystal filter arranged in the right eye lens is opened to pass light therethrough, and the shutter in the liquid crystal filter arranged in the left eye lens is closed to block light, thereby allowing only the right eye to see the right-eye video. In synchronization with the timing at which switching to the left-eye video is performed, the shutter in the liquid crystal filter arranged in the left eye lens is opened to pass light therethrough, and the shutter in the liquid crystal filter arranged in the right eye lens is closed to block light, thereby allowing only the left eye to see the left-eye video. The timing at which the right-eye video and the left-eye video are switched, and the timing at which the shutters in the liquid crystal filters are opened/closed are synchronized with each other through wireless or wired connection between the display panel and the visor.

These operations are alternately repeated to enable a viewer to see stereoscopic video through the right-eye video and the left-eye video. Such stereoscopic video display devices using the shutter-type visor are disclosed, for example, in Patent Literature 1 and Patent Literature 2.

In addition, Patent Literature 3 discloses a configuration whereby display of not only three-dimensional stereoscopic video but also of ordinary two-dimensional video is made possible in a stereoscopic video display device using a shutter-type visor. That is, the stereoscopic video display device is rendered to allow enjoyment of video also in situations where the shutter-type visor is not used. In accordance with a signal selection switch, this stereoscopic video display device displays three-dimensional stereoscopic video as a master screen on the display-panel screen, and displays ordinary two-dimensional video as a slave screen.

### CITATION LIST

### Patent Literature

[PTL 1] Japanese Laid-Open Patent Publication No. 2000-36939

[PTL 2] Japanese Laid-Open Patent Publication No. H10-240212

[PTL 3] Japanese Laid-Open Patent Publication No. H1-144797

### SUMMARY OF THE INVENTION

### Problems to be Solved by the Invention

The above-described conventional stereoscopic video display devices either display three-dimensional stereoscopic video or dual video—three-dimensional stereoscopic video and ordinary two dimensional video—on their display-panel screen. They do not, however, otherwise display at least two three-dimensional stereoscopic video footages simultaneously on one screen. Conventional stereoscopic video display devices lack the convenience that would allow viewers to simultaneously watch a plurality of three-dimensional stereoscopic video footages displayed on one screen at the same time. Another problem is that even if a plurality of stereoscopic video footages were simultaneously displayed, unless the timing at which the right-eye video of the plurality of stereoscopic video footages is displayed is synchronized and the timing at which the left-eye video of the plurality of stereoscopic video footages is displayed is synchronized, a viewer would not be able to see the plurality of stereoscopic video footages as proper stereoscopic video footages.

The present invention has been made in order to solve the problems described above, and One non-limiting and exemplary embodiment of the present invention provides a stereoscopic video display device having improved convenience which simultaneously displays a plurality of stereoscopic video footages on one screen, thereby allowing a viewer to simultaneously view the plurality of stereoscopic video footages.

### Solution to the Problems

In order to attain the object described above, a stereoscopic video display device of the present invention includes a display panel in which a screen for displaying a plurality of stereoscopic video footages is arranged; and a video control section configured to control the display of the plurality of stereoscopic video footages. Each of the plurality of stereoscopic video footages includes right-eye video and left-eye video each having parallax with respect to the other. The video control section simultaneously displays the plurality of stereoscopic video footages in given positions on the screen and periodically displays the right-eye video and the left-eye video. The video control section synchronizes the timing at which the right-eye video of at least two stereoscopic video footages among the plurality of stereoscopic video footages is displayed and synchronizes the timing at which the left-eye video of the at least two stereoscopic video footages is displayed.

### Advantageous Effects of the Invention

According to the stereoscopic video display device of the present invention, since the video control section simultaneously displays the plurality of stereoscopic video footages in the given positions on the screen, the viewer is allow to simultaneously view the plurality of stereoscopic video footages, improving convenience.

In particular, according to the stereoscopic video display device, the timing at which the right-eye video of the at least two video footages among the plurality of video footages is displayed is synchronized and the timing at which the left-eye video of the at least two video footages is displayed is synchronized. Thus, the right-eye video of the at least two video footages is displayed on the screen at the same timing and the left-eye video of the at least two video footages is displayed on the screen at the same timing.

In other words, when the viewer watches the plurality of video footages with the shutter-type visor, the viewer can simultaneously see, as proper video footages, at least the two video footages in which the timing at which the right-eye video and the left-eye video are displayed is synchronized. This is because opening/closing of the shutters of the shutter visor is synchronized with the timing at which the right-eye video and the left-eye video are displayed. On the other hand, video footages in which the timing at which the right-eye video and the left-eye video are displayed is not synchronized as in the present invention would otherwise become fragmented video footages and thus could not be watched as proper stereoscopic video footages.

Therefore, when a plurality of video footages are displayed on one screen, the timing at which right-eye video of the plurality of video footages that the viewer desires to see as proper video footages is displayed suffices to be synchronized and the timing at which left-eye video of the plurality of video footages is displayed suffices to be synchronized. By so doing, the plurality of stereoscopic video footages can be reliably viewed simultaneously. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a relationship between a shutter-type visor and a stereoscopic video display device according to an embodiment as one mode of the present disclosure.

FIG. 2 is a front view of a display panel when a video footage is displayed on the stereoscopic video display device according to the embodiment as one mode of the present disclosure.

FIG. 3 is a schematic diagram for illustrating video including right-eye video and left-eye video.

FIG. 4 is a front view of the display panel when a plurality of video footages are displayed.

FIG. 5 is a schematic diagram for illustratively explaining first video that has been downscaled, the first video including right-eye video and left-eye video.

FIG. 6 is a schematic diagram for illustratively explaining second video that has been downscaled, the second video including right-eye video and left-eye video.

FIG. 7A is a signal waveform diagram showing a relationship between a first video frame signal and an LR discriminating signal.

FIG. 7B is a signal waveform diagram showing a relationship between a second video frame signal and an LR discriminating signal.

FIG. 8A is a functional block diagram of a video control section 240 performing first frame processing.

FIG. 8B is a flowchart showing an example of an operation of the video control section 240.

FIG. 8C is a functional block diagram of the video control section 240 performing the first frame processing.

FIG. 8D is a functional block diagram of the video control section 240 performing the first frame processing.

FIG. 9A is a signal waveform diagram showing a relationship between a first video frame signal and a second video frame signal that are asynchronous with each other.

FIG. 9B is a signal waveform diagram showing a relationship between a first video frame signal and a second video frame signal that are synchronized with each other.

FIG. 10A is a functional block diagram of the video control section 240 performing second frame processing.

FIG. 10B is a functional block diagram of the video control section 240 performing the second frame processing.

FIG. 11 is a diagram of an example of formats for video frame signals used in a second embodiment.

FIG. 12 is a block diagram showing an example of the configuration of a stereoscopic video display device 200 according to a third embodiment.

FIG. 13 is a diagram showing a correspondence relationship between a first video frame signal and a second video frame signal according to the third embodiment.

### DESCRIPTION OF EMBODIMENTS

### First Embodiment

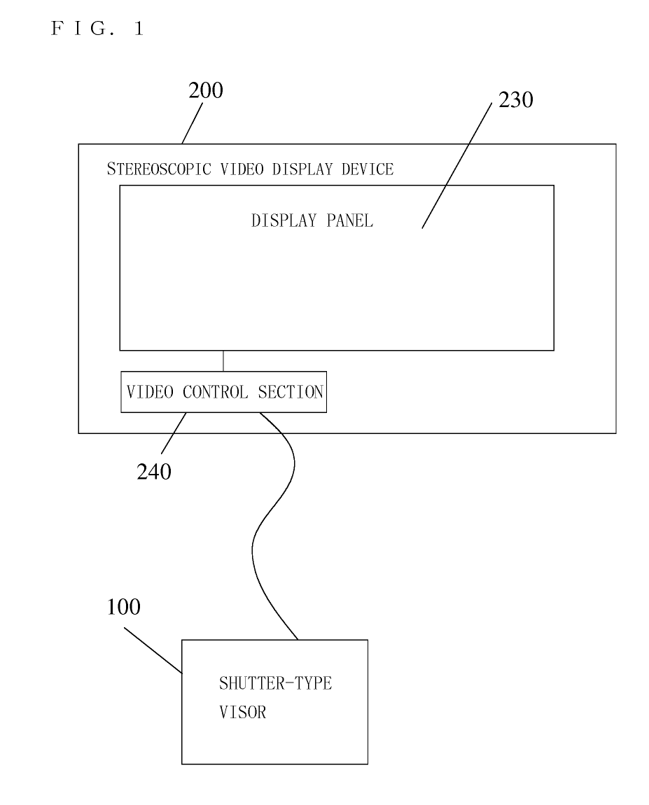

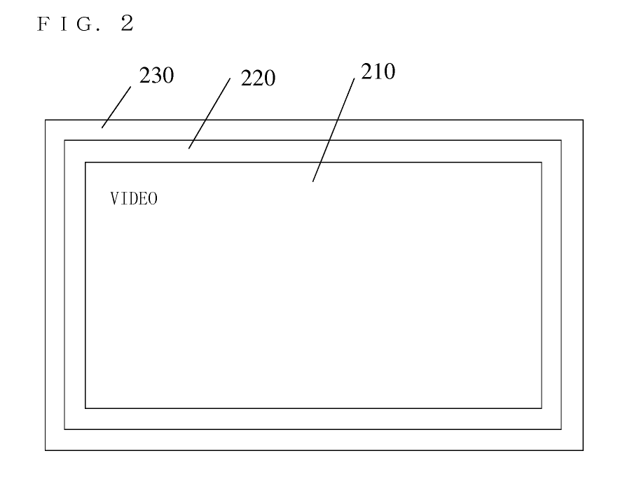

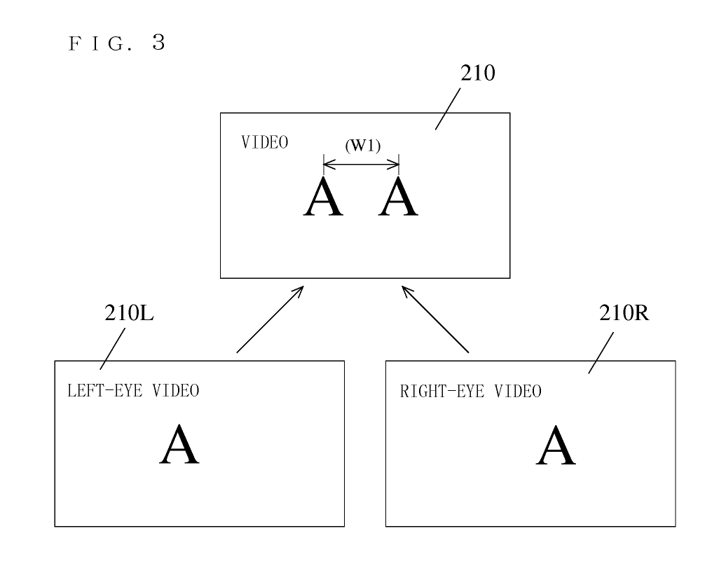

Hereinafter, a stereoscopic video display device according to an embodiment as one mode of the present disclosure will be described with reference to the drawings. FIG. 1 is a block diagram showing a relationship between a shutter-type visor and a stereoscopic video display device according to an embodiment as one mode of the present disclosure. FIG. 2 is a front view of a display panel when a video footage is displayed on the stereoscopic video display device. FIG. 3 is a schematic diagram for illustrating video including right-eye video and left-eye video.

<Relationship Between a Shutter-Type Visor 100 and a Stereoscopic Video Display Device 200>

First, the relationship between a shutter-type visor 100 and a stereoscopic video display device 200 will be described. In FIG. 1, the stereoscopic video display device 200 includes a display panel 230 in which a screen that displays video is arranged and a video control section 240 that controls the display of the video. In FIG. 2, a screen 220 displaying video 210 is arranged in the display panel 230. As the display panel 230, for example, a plasma display panel, a liquid crystal panel, or the like is used.

As shown in FIG. 3, the video 210 includes right-eye video 210R and left-eye video 210L having a parallax therebetween. The video control section 240 performs control such that the right-eye video 21 OR and the left-eye video 210L, which have the parallax therebetween, are alternately displayed on the screen 220 of the display panel 230. When the right-eye video 21 OR is displayed, the right-eye video 21 OR is viewed with the right eye, and when the left-eye video 210L is displayed, the left-eye video 210L is viewed with the left eye. Since the right-eye video 21 OR and the left-eye video 210L have the parallax therebetween, the video 210 is stereoscopically viewed.

In FIG. 3, a character “A” is displayed in each of the right-eye video 210R and the left-eye video 210L. When the right-eye video 21 OR and the left-eye video 210L are alternately displayed on the screen 220 of the display panel 230, the viewer see them as the video 210 having a parallax (W1). In other words, the viewer sees the video 210 in a three-dimensional manner. With respect to the video 210, its sense of depth and its sense of projection change in response to the parallax (W1) between the right-eye video 210R and the left-eye video 210L. When the parallax (W1) is large, the depth and the projection are also increased, and when the parallax (W1) is small, the depth and the projection are also decreased.

In order to view the right-eye video 21 OR with the right eye and the left-eye video 210L with the left eye, for example, the shutter-type visor 100 is used. In the shutter-type visor 100, liquid crystal filters that switch between passage and blocking of light are arranged in a right eye lens and a left eye lens. By opening and closing the shutters in the liquid crystal filters, passage and blocking of light are switched.

Specifically, in synchronization with the timing at which the right-eye video 210R/the left-eye video 210L are switched to be displayed on the display panel 230, the timing at which the shutters in the liquid crystal filters arranged in the right eye lens and the left eye lens are opened/closed is switched. In other words, in synchronization with the timing at which the right-eye video 21 OR is to be displayed, the shutter in the liquid crystal filter arranged in the right eye lens is opened to pass light therethrough, and the shutter in the liquid crystal filter arranged in the left eye lens is closed to block light, thereby allowing only the right eye to see the right-eye video 210R. In synchronization with the timing at which the left-eye video 210L is to be displayed, the shutter in the liquid crystal filter arranged in the left eye lens is opened to pass light therethrough, and the shutter in the liquid crystal filter arranged in the right eye lens is closed to block light, thereby allowing only the left eye to see the left-eye video 210L. The timing at which the right-eye video 210R and the left-eye video 210L are switched and the timing at which the shutters in the liquid crystal filters are opened/closed are synchronized with each other through wireless or wired connection between the display panel 230 and the visor 100. Opening/closing of the shutters is repeated to allow the viewer to see the stereoscopic video 210 through the right-eye video 210R and the left-eye video 210L having the parallax therebetween.

<A Case Where a Plurality of the Video Footages 210 are Displayed on the Display Panel 230>

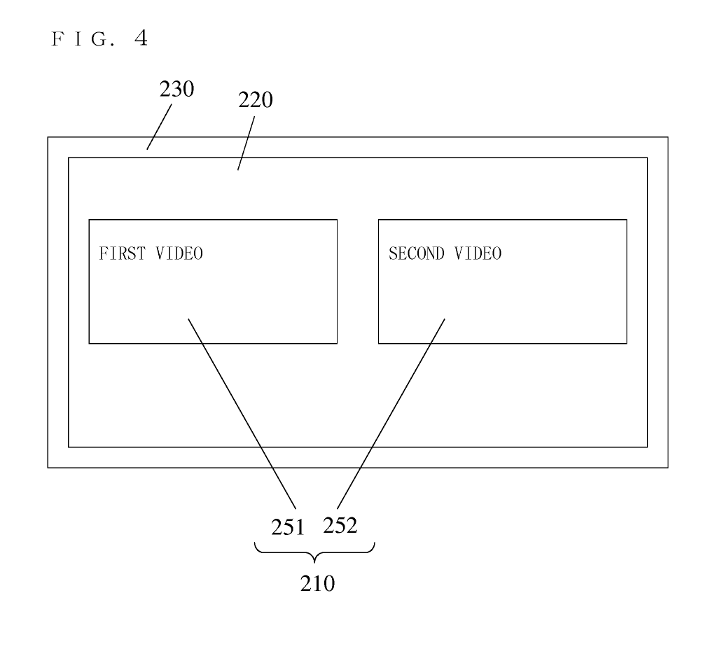

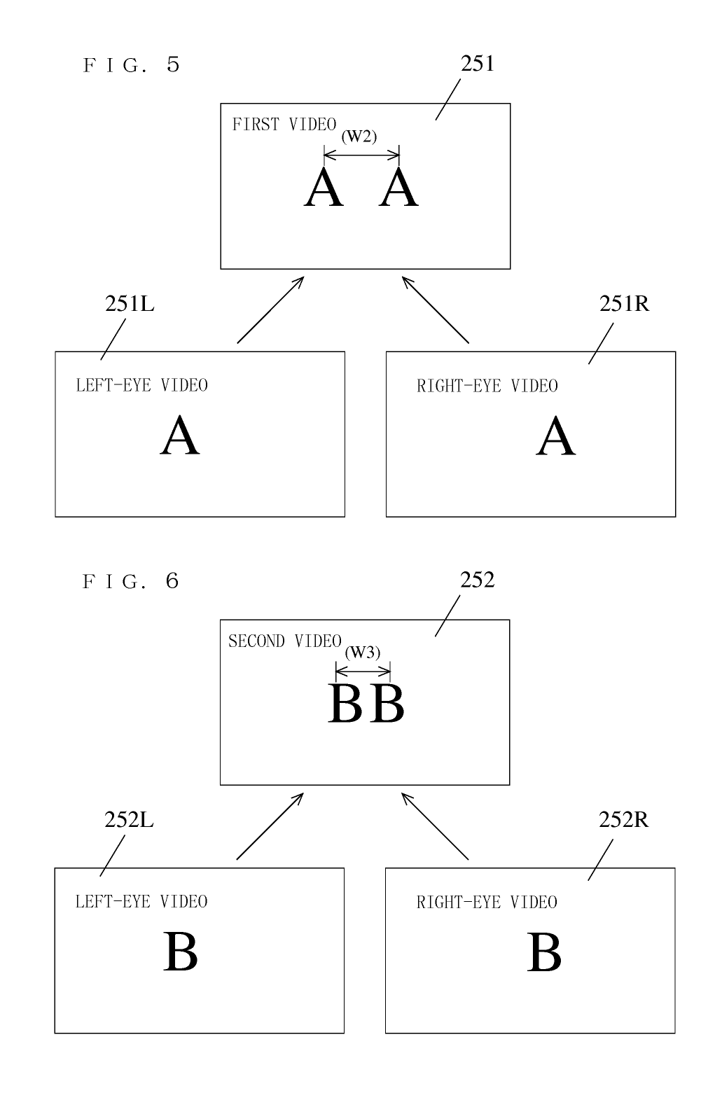

Next, a case where a plurality of the video footages 210 are displayed on the display panel 230 will be described. FIG. 4 is a front view of the display panel when a plurality of video footages are displayed. FIG. 5 is a schematic diagram for illustrating first video that has been downscaled, the first video including right-eye video and left-eye video. FIG. 6 is a schematic diagram for illustrating second video that has been downscaled, the second video including right-eye video and left-eye video.

In FIG. 4, first video 251 and second video 252 are simultaneously displayed in given positions on the screen 220 of the display panel 230. The contents of the first video 251 and the second video 252 may be different from each other or the same, or may be video contents received from a broadcasting company or video contents recorded on a medium, that is, various types of video contents can be used as the first video 251 and the second video 252. The first video 251 and the second video 252 have been processed by the video control section 240 into video footages downscaled with relative to the original video 210 and are simultaneously displayed on the screen 220. As shown in FIG. 5, similarly to the original video 210, the downscaled first video 251 includes right-eye video 251R and left-eye video 251L having a parallax therebetween. In addition, as shown in FIG. 6, similarly to the original video 210, the downscaled second video 252 includes right-eye video 252R and left-eye video 252L having a parallax therebetween.

<Differences in Parallax Between a Plurality of the Video Footages 210>

Next, the differences in parallax between a plurality of the video footages 210 will be described.

First, the downscaled first video 251 will be described. In the downscaled first video 251, a character “A” is displayed in each of the right-eye video 251R and the left-eye video 251L. When the right-eye video 251R and the left-eye video 251L are alternately displayed on the screen 220 of the display panel 230, the viewer sees the first video 251 as stereoscopic video having a parallax (W2). In other words, the viewer can see the first video 251 as stereoscopic video having a sense of projection and a sense of depth that correspond to the parallax (W2).

Here, when the downscaled first video 251 is compared to the original video 210 before being downscaled, the parallax (W2) of the downscaled first video 251 has become smaller than the parallax (W1) of the original video 210. Due to the decrease in parallax, the sense of projection and the sense of depth of the first video 251 are decreased as compared to those of the original vide 210.

Next, the downscaled second video 252 will be described. In the downscaled second video 252, a character “B” is displayed in each of the right-eye video 252R and the left-eye video 252L. When the right-eye video 252R and the left-eye video 252L are alternately displayed on the screen 220 of the display panel 230, the viewer sees the second video 252 as stereoscopic video having a parallax (W3). In other words, the viewer can see the second video 252 as stereoscopic video having a sense of projection and a sense of depth that correspond to the parallax (W3).

Here, when the downscaled second video 252 is compared to the original video 210 before being downscaled, the parallax (W3) of the downscaled second video 252 has become smaller than the parallax (W1) of the original video 210. Due to the decrease in parallax, the sense of projection and the sense of depth of the second video 252 are decreased as compared to those of the original video 210.

In addition, when the first video 251 and the second video 252 are compared to each other, the parallax (W3) of the second video 252 has become smaller than the parallax (W2) of the first video 251. Due to the difference in parallax, the sense of projection and the sense of depth of the second video 252 are decreased as compared to those of the first video 251. Since the first video 251 and the second video 252 have been downscaled as compared to the original video 210 as described above, the parallaxes thereof have also become small.

Further, when the first video 251 and the second video 252 are simultaneously displayed on the screen 220, if the parallax (W2) of the first video 251 and the parallax (W3) of the second video 252 are different from each other, the viewer feels that the sense of projection and the sense of depth are also different between the first video 251 and the second video 252. In addition, there may be a case where the sense of projection and the sense of depth are greatly different between the first video 251 and the second video 252, depending on video production designs and the like.

<Display of the First Video 251 and the Second Video 252>

Next, display of the first video 251 and the second video 252 will be described.

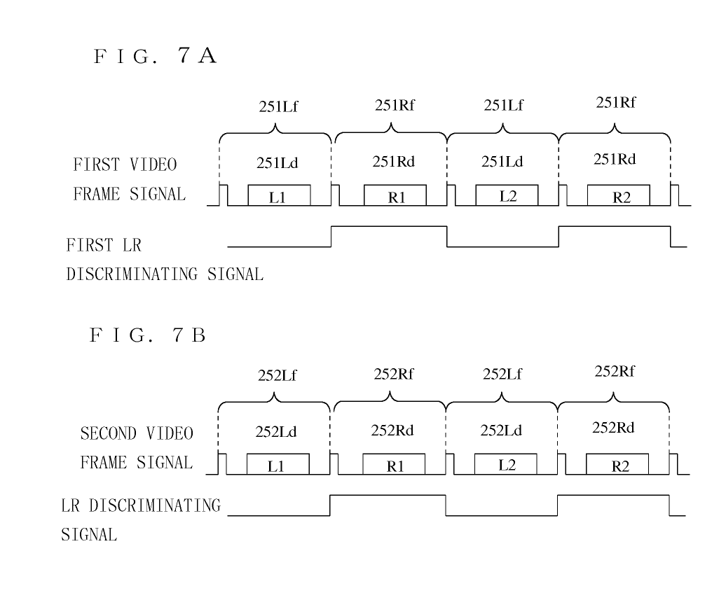

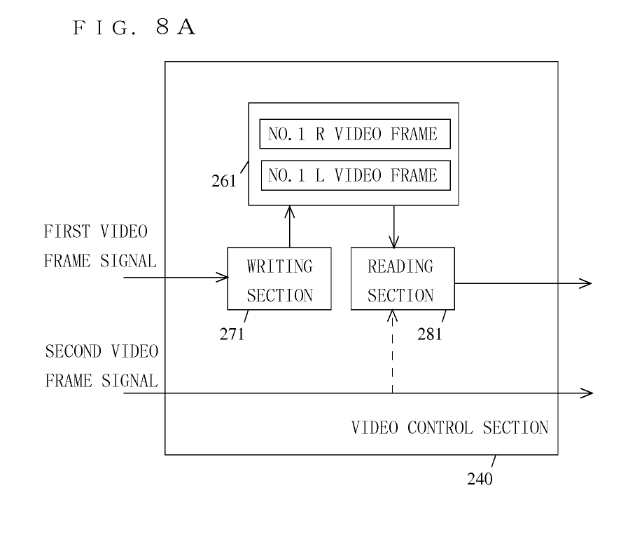

The first video 251 is formed on the basis of a first video frame signal. The second video 252 is formed on the basis of a second video frame signal. FIG. 7A is a signal waveform diagram showing a relationship between the first video frame signal and an LR discriminating signal. As shown in FIG. 7A, the first video frame signal has a plurality of No. 1 R video frames 251Rf and a plurality of No. 1 L video frames 251Lf. The right-eye video 251R is formed on the basis of the No. 1 R video frames 251Rf, and the left-eye video 251L is formed on the basis of the No. 1 L video frames 251Lf. The plurality of No. 1 R video frames 251Rf include video data 251Rd of the right-eye video 251R. In addition, the plurality of No. 1 L video frames 251Lf include video data 251Ld of the left-eye video 251L. The first video 251 is displayed on the basis of the first video frame signal composed of the No. 1 R video frames 251Rf and the No. 1 L video frames 251Lf. To the No. 1 R video frames 251Rf and the No. 1 L video frames 251Lf, LR discriminating signals corresponding to the No. 1 R video frames 251Rf and the No. 1 L video frames 251Lf, respectively, are assigned.

One right-eye video footage 251R corresponds to one No. 1 R video frame 251Rf, and one left-eye video footage 251L corresponds to one No. 1 L video frame 251Lf. When the right-eye video 251R and the left-eye video 251L are alternately displayed as the first video 251 on the screen 220, for example, the first right-eye video footage 251R is displayed on the basis of the first No. 1 R video frame 251Rf, and the first left-eye video footage 251L is displayed on the basis of the first No. 1 L video frame 251Lf. In addition, the second right-eye video footage 251R is displayed on the second No. 1 R video frame 251Rf, and the second left-eye video footage 251L is displayed on the basis of the second No. 1 L video frame 251Lf. Further, the third right-eye video footage 251R is displayed on the basis of the third No. 1 R video frame 251Rf, and the third left-eye video footage 251L is displayed on the basis of the third No. 1 L video frame 251Lf. Thereafter, such operations are repeated.

In addition, FIG. 7B is a signal waveform diagram showing a relationship between the second video frame signal and an LR discriminating signal. As shown in FIG. 7B, the second video frame signal has a plurality of No. 2 R video frames 252Rf and a plurality of No. 2 L video frames 252Lf. The right-eye video 252R is formed on the basis of the No. 2 R video frames 252Rf, and the left-eye video 252L is formed on the basis of the No. 2 L video frames 252Lf. The plurality of No. 2 R video frames 252Rf include video data 252Rd of the right-eye video 252R. In addition, the plurality of No. 2 L video frames 252Lf include video data 252Ld of the left-eye video 252L. The second video 252 is displayed on the basis of the second video frame signal composed of the No. 2 R video frames 252Rf and the No. 2 L video frames 252Lf. To the No. 2 R video frames 252Rf and the No. 2 L video frames 252Lf, LR discriminating signals corresponding to the No. 2 R video frames 252Rf and the No. 2 L video frames 252Lf, respectively, are assigned.

One right-eye video footage 252R corresponds to one No. 2 R video frame 252Rf, and one left-eye video footage 252L corresponds to one No. 2 L video frame 252Lf. When the right-eye video 252R and the left-eye video 252L are alternately displayed as the second video 252 on the screen 220, for example, the first right-eye video footage 252R is displayed on the basis of the first No. 2 R video frame 252Rf, and the first left-eye video footage 252L is displayed on the basis of the first No. 2 L video frame 252Lf. In addition, the second right-eye video footage 252R is displayed on the basis of the second No. 2 R video frame 252Rf, and the second left-eye video footage 252L is displayed on the basis of the second No. 2 L video frame 252Lf. Further, the third right-eye video footage 252R is displayed on the basis of the third No. 2 R video frame 252Rf, and the third left-eye video footage 252L is displayed on the basis of the third No. 2 L video frame 252Lf. Thereafter, such operations are repeated.

<First Frame Processing by the Video Control Section 240>

Next, frame processing by the video control section 240 will be described. There are several methods for the frame processing.

First, first frame processing will be described.

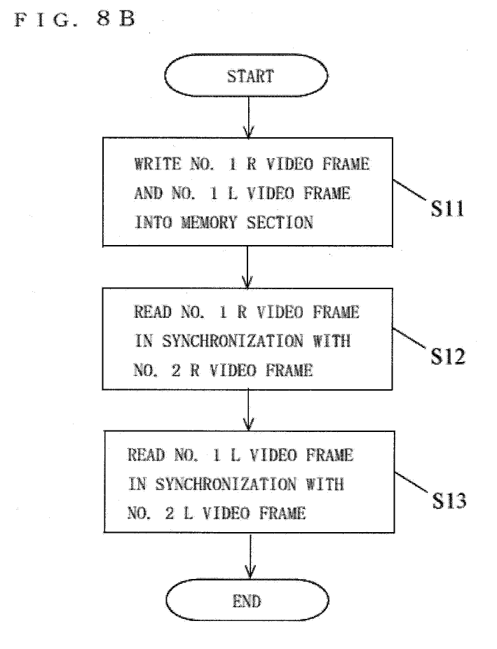

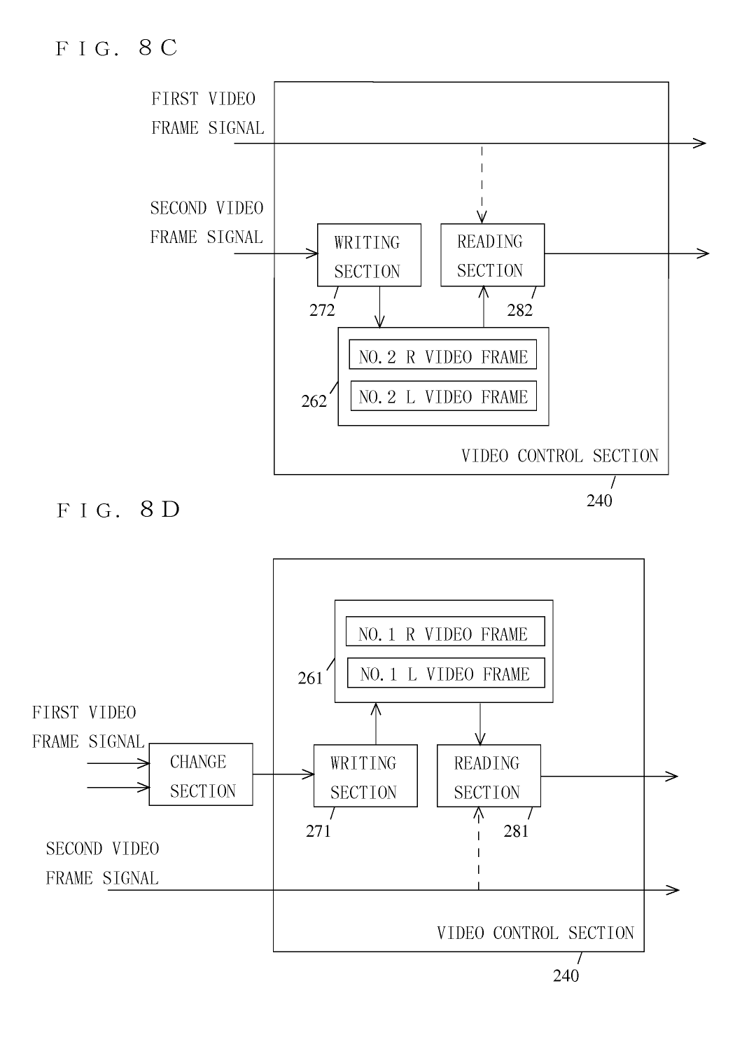

FIG. 8A is a functional block diagram of the video control section 240 performing the first frame processing. As shown in FIG. 8A, the video control section 240 includes a memory section 261, a writing section 271, and a reading section 281. The memory section 261 has an area for storing the No. 1 R video frames 251Rf of the right-eye video 251R and the No. 1 L video frames 251Lf of the left-eye video 251L in the first video frame signal. The writing section 271 writes the No. 1 R video frames 251Rf and the No. 1 L video frames 251Lf into the memory section 261. The reading section 281 reads the No. 1 R video frames 251Rf and the No. 1 L video frames 251Lf from the memory section 261.

The video control section 240 periodically displays the No. 1 R video frames 251Rf read from the reading section 281, as the right-eye video 251R, and the No. 1 L video frames 251Lf read from the reading section 281, as the left-eye video 251L, on the screen 220. In this case, the video control section 240 displays the No. 1 R video frames 251Rf and the No. 1 L video frames 251Lf on the screen 220 in synchronization with the No. 2 R video frames 252Rf of the right-eye video 252R and the No. 2 L video frames 252Lf of the left-eye video 252L in the second video frame signal.

Specifically, an operation of the video control section 240 is as follows. As shown in FIG. 7B, the second video frame signal includes a plurality of the No. 2 R video frames 252Rf and a plurality of the No. 2 L video frames 252Lf. FIG. 8B is a flowchart showing an example of the operation of the video control section 240. As shown in FIG. 8B, the writing section 271 extracts a No. 1 R video frame 251Rf and a No. 1 L video frame 251Lf from the first video frame signal and writes these video frames into the memory section 261 (Step S11). When reading the No. 1 R video frame 251Rf and the No. 1 L video frame 251Lf that are stored in the memory section 261, the reading section 281 reads the No. 1 R video frame 251Rf in synchronization with a No. 2 R video frame 252Rf (Step S12). In addition, the reading section 281 reads the No. 1 L video frame 251Lf in synchronization with a No. 2 L video frame 252Lf (Step S13). It should be noted that the order of Steps S12 and S13 may be reversed. Thereafter, the operations at Steps S11 to S13 are repeated. By so doing, the video control section 240 synchronizes the No. 1 R video frames 251Rf with the No. 2 R video frames 252Rf and the No. 1 L video frames 251Lf with the No. 2 L video frames 252Lf. The memory section 261 suffices to have an area for storing one of the No. 1 R video frames 251Rf and one of the No. 1 L video frames 251Lf, namely, two frames in total.

In the following description, for convenience's sake, the LR discriminating signal in the first video frame signal is referred to as a first LR discriminating signal, and the LR discriminating signal in the second video frame signal is referred to as a second LR discriminating signal. The No. 1 R video frames 251Rf and the No. 1 L video frames 251Lf in the first video frame signal can be discriminated from each other by the first LR discriminating signal. In addition, the No. 2 R video frames 252Rf and the No. 2 L video frames 252Lf in the second video frame signal can be discriminated from each other by the second LR discriminating signal. Thus, the reading section 281 synchronizes the timing at which the No. 1 R video frame 251Rf and the No. 1 L video frame 251Lf stored in the memory section 261 are read with the timing at which the No. 2 R video frame 252Rf and the No. 2 L video frame 252Lf are read, by utilizing these first and second LR discriminating signals.

It should be noted that the first LR discriminating signal can be generated on the basis of a V synchronization signal of the first video frame signal. The V synchronization signal of the first video frame signal is included in each of the No. 1 R video frames 251Rf and the No. 1 L video frames 251Lf. In addition, the second LR discriminating signal can be generated on the basis of a V synchronization signal of the second video frame signal. The V synchronization signal of the second video frame signal is included in each of the No. 2 R video frames 252Rf and the No. 2 L video frames 252Lf. Per each of these V synchronization signals, the No. 1 R video frames 251Rf and the No. 1 L video frames 251Lf are separated from each other, and the No. 2 R video frames 252Rf and the No. 2 L video frames 252Lf are separated from each other.

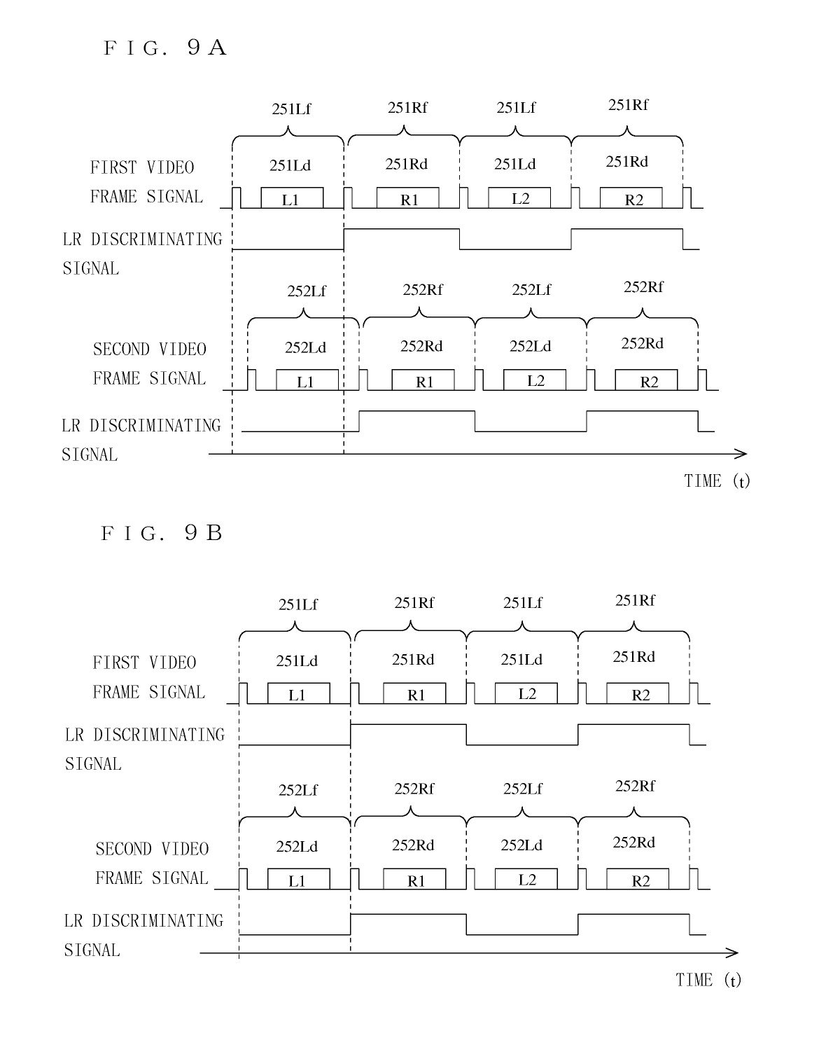

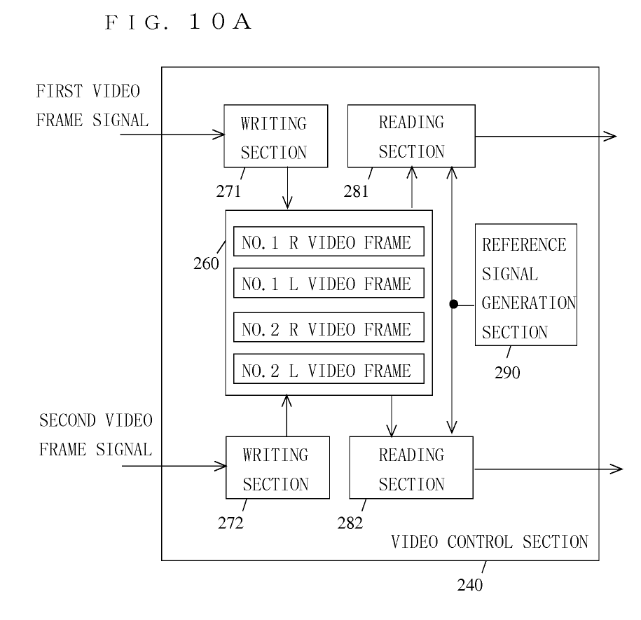

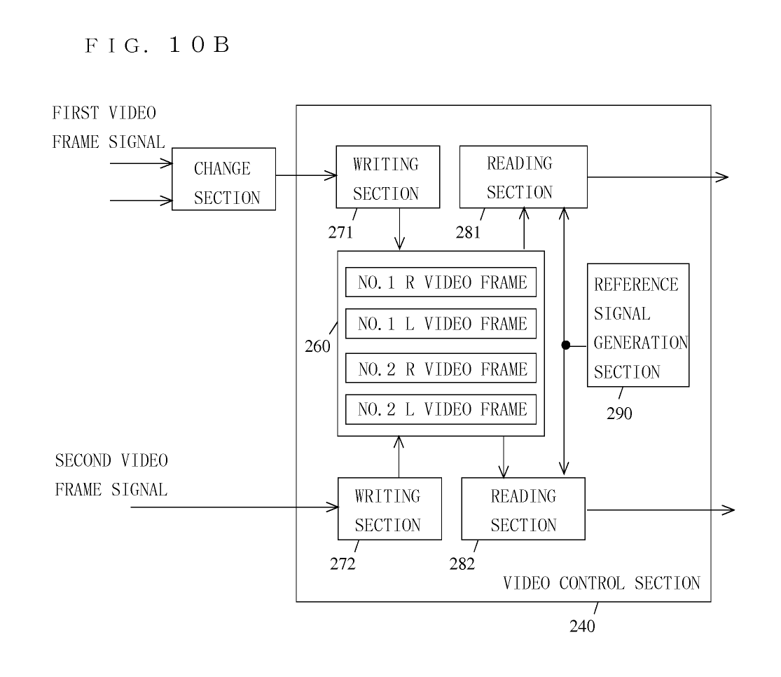

For example, as shown in FIG. 9A, a case is assumed where the No. 1 R video frames 251Rf and the No. 1 L video frames 251Lf in the first video frame signal are not synchronized with the No. 2 R video frames 252Rf and the No. 2 L video frames 252Lf in the second video frame signal. In such a case as well, by performing the first frame processing described above, the video control section 240 can synchronize the No. 1 R video frames 251Rf and the No. 1 L video frames 251Lf in the first video frame signal with the No. 2 R video frames 252Rf and the No. 2 L video frames 252Lf in the second video frame signal as shown in FIG. 9B.

It should be noted that the video control section 240 may have a configuration as shown in FIG. 8C. In FIG. 8C, a memory section 262 has an area for storing the No. 2 R video frames 252Rf of the right-eye video 252R and the No. 2 L video frames 252Lf of the left-eye video 252L in the second video frame signal. A writing section 272 writes the No. 2 R video frames 252Rf and the No. 2 L video frames 252Lf into the memory section 262. A reading section 282 reads the No. 2 R video frames 252Rf and the No. 2 L video frames 252Lf from the memory section 262.

The video control section 240 periodically displays the No. 2 R video frames 252Rf read from the reading section 282, as the right-eye video 252R, and the No. 2 L video frames 252Lf read from the reading section 282, as the left-eye video 252L, on the screen 220. In this case, the video control section 240 displays the No. 2 R video frames 252Rf and the No. 2 L video frames 252Lf on the screen 220 in synchronization with the No. 1 R video frames 251Rf of the right-eye video 251R and the No. 1 L video frames 251Lf of the left-eye video 251L in the first video frame signal.

<Switching to Another Video Footage Using the First Frame Processing>

Next, switching to another video footage using the first frame processing will be described. An operation of the stereoscopic video display device 200 when any one video footage is switched to another video footage in the case where a plurality of video footages are displayed on the screen 220 will be described. In order to perform such switching, the stereoscopic video display device 200 is provided with a change section (see FIG. 8D) that changes input of at least one video footage among the plurality of video footages and inputs a new video footage. The video control section 240 synchronizes the timing at which the right-eye video of at least two video footages, including the video footage changed by the change section and another video footage, is displayed, and synchronizes the timing at which the left-eye video of the at least two video footages is displayed. The video control section 240 delays the timing at which the video footage changed by the change section is displayed, to synchronize the timing at which the right-eye video of all the video footages is displayed and to synchronize the timing at which the left-eye video of all the video footages is displayed.

Specifically, the video control section 240 operates as follows. For example, as shown in FIG. 4, the first video 251 and the second video 252 are displayed on the screen 220. When the first video 251 is switched, the video control section 240 synchronizes the timing at which the right-eye video 251R of the switched first video 251 is displayed with the timing at which the right-eye video 252R of the second video 252 is displayed and synchronizes the timing at which the left-eye video 251L of the switched first video 251 is displayed with the timing at which the left-eye video 252L of the second video 252 is displayed. At that time, the video control section 240 delays the timing at which the switched first video 251 is displayed, to synchronize the timing at which the right-eye video 251R of the first video 251 is displayed with the timing at which the right-eye video 252R of the second video 252 is displayed and to synchronize the timing at which the left-eye video 251L of the first video 251 is displayed with the timing at which the left-eye video 252L of the second video 252 is displayed.

In this case, the video control section 240 adjusts the delays of the right-eye video frames 251Rf and the left-eye video frames 251Lf of the first video 251 such that the right-eye video frames 251Rf and the left-eye video frames 251Lf are synchronized with the right-eye video frames 252Rf and the left-eye video frames 252Lf of the second video 252. When the second video 252 is switched, the video control section 240 synchronizes the timing at which the right-eye video 252R of the switched second video 252 is displayed with the timing at which the right-eye video 251R of the first video 251 is displayed and synchronizes the timing at which the left-eye video 252L of the switched second video 252 is displayed with the timing at which the left-eye video 251L of the first video 251 is displayed.

<Second Frame Processing by the Video Control Section 240>

Next, second frame processing will be described.

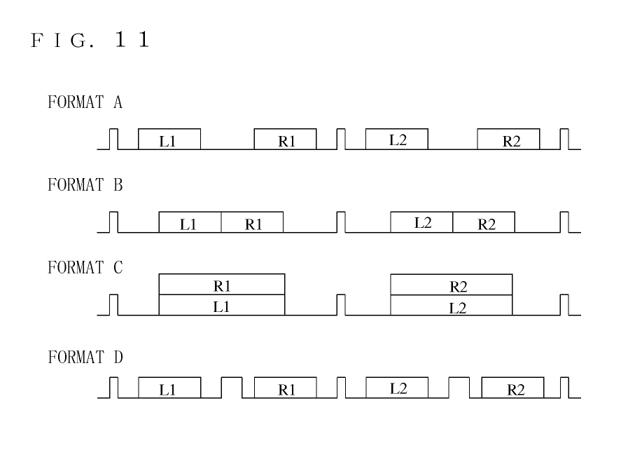

FIG. 10A is a functional block diagram of the video control section 240 performing the second frame processing. As shown in FIG. 10A, the video control section 240 includes a memory section 260, writing sections 271 and 272, reading sections 281 and 282, and a reference signal generation section 290. The memory section 260 has an area for storing the No. 1 R video frames 251Rf of the right-eye video 251R and the No. 1 L video frames 251Lf of the left-eye video 251L in the first video frame signal and for storing the No. 2 R video frames 252Rf of the right-eye video 252R and the No. 2 L video frames 252Lf of the left-eye video 252L in the second video frame signal. The writing section 271 writes the No. 1 R video frames 251Rf and the No. 1 L video frames 251Lf into the memory section 260. The writing section 272 writes the No. 2 R video frames 252Rf and the No. 2 L video frames 252Lf into the memory section 260. The reading section 281 reads the No. 1 R video frames 251Rf and the No. 1 L video frames 251Lf from the memory section 260. The reading section 282 reads the No. 2 R video frames 252Rf and the No. 2 L video frames 252Lf from the memory section 260. The reference signal generation section 290 generates a reference signal. The reference signal will be described later.

In addition, the video control section 240 periodically displays the No. 1 R video frames 251Rf read from the reading section 281, as the right-eye video 251R, and the No. 1 L video frames 251Lf read from the reading section 281, as the left-eye video 251L, on the screen 220. In this case, the video control section 240 displays the No. 1 R video frames 251Rf and the No. 1 L video frames 251Lf on the screen 220 in synchronization with the No. 2 R video frames 252Rf of the right-eye video 252R and the No. 2 L video frames 252Lf of the left-eye video 252L in the second video frame signal.

Specifically, the video control section 240 operates as follows. As shown in FIG. 7B, the second video frame signal includes a plurality of the No. 2 R video frames 252Rf and a plurality of the No. 2 L video frames 252Lf. In FIG. 10A, when reading the No. 1 R video frames 251Rf, the No. 1 L video frames 251Lf, the No. 2 R video frames 252Rf, and the No. 2 L video frames 252Lf that are stored in the memory section 260, the reading sections 281 and 282 read the No. 1 R video frames 251Rf and the No. 2 R video frames 252Rf in synchronization with the reference signal and read the No. 1 L video frames 251Lf and the No. 2 L video frames 252Lf in synchronization with the reference signal. By so doing, the No. 1 R video frames 251Rf and the No. 1 L video frames 251Lf are synchronized with the No. 2 R video frames 252Rf and the No. 2 L video frames 252Lf.

It should be noted that the reference signal generation section 290 may generate the reference signal such that the reference signal is asynchronous with the first video frame signal having the No. 1 R video frames 251Rf and the No. 1 L video frames 251Lf and the second video frame signal having the No. 2 R video frames 252Rf and the No. 2 L video frames 252Lf, or may generate the reference signal such that the reference signal is synchronous with either the first video frame signal or the second video frame signal. Alternatively, the reference signal generation section 290 may generate the reference signal at a timing delayed based on the first video frame signal or the second video frame signal. In addition, the memory section 260 suffices to have an area for storing one of the No. 1 R video frames 251Rf, one of the No. 1 L video frames 251Lf, one of the No. 2 R video frames 252Rf, and one of the No. 2 L video frames 252Lf, namely, four frames in total.

The No. 1 R video frames 251Rf and the No. 1 L video frames 251Lf in the first video frame signal can be discriminated from each other by the first LR discriminating signal. In addition, the No. 2 R video frames 252Rf and the No. 2 L video frames 252Lf in the second video frame signal can be discriminated from each other by the second LR discriminating signal. Thus, when reading the No. 1 R video frame 251Rf, the No. 1 L video frame 251Lf, the No. 2 R video frame 252Rf, and the No. 2 L video frame 252Lf that are stored in the memory section 260, the reading sections 281 and 282 perform synchronization by utilizing the first and second LR discriminating signals and the reference signal.

It should be noted that the first LR discriminating signal can also be generated on the basis of the V synchronization signal of the first video frame signal. The V synchronization signal of the first video frame signal is included in each of the No. 1 R video frames 251Rf and the No. 1 L video frames 251Lf. The second LR discriminating signal can also be generated on the basis of the V synchronization signal of the second video frame signal. The V synchronization signal of the second video frame signal is included in each of the No. 2 R video frames 252Rf and the No. 2 L video frames 252Lf. Per each of these V synchronization signals, the No. 1 R video frames 251Rf and the No. 1 L video frames 251Lf are separated from each other, and the No. 2 R video frames 252Rf and the No. 2 L video frames 252Lf are separated from each other.

For example, as shown in FIG. 9A, a case is assumed where the No. 1 R video frames 251Rf and the No. 1 L video frames 251Lf in the first video frame signal are not synchronized with the No. 2 R video frames 252Rf and the No. 2 L video frames 252Lf in the second video frame signal. In such a case as well, by performing the second frame processing described above, the No. 1 R video frames 251Rf and the No. 1 L video frames 251Lf in the first video frame signal can be synchronized with the No. 2 R video frames 252Rf and the No. 2 L video frames 252Lf in the second video frame signal as shown in FIG. 9B.

<Switching to Another Video Footage by Using the Second Frame Processing>

Next, switching to another video footage using the second frame processing will be described. An operation of the stereoscopic video display device 200 when any one video footage is switched to another video footage in the case where a plurality of video footages are displayed on the screen 220 will be described. In order to perform such switching, the stereoscopic video display device 200 is provided with a change section (see FIG. 10B) that changes input of at least one video footage among the plurality of video footages and inputs a new video footage. In the stereoscopic video display device 200, the video control section 240 synchronizes the timing at which the right-eye video of at least two video footages, including the video footage changed by the change section and another video footage, is displayed, and synchronizes the timing at which the left-eye video of the at least two footages is displayed. The video control section 240 delays the timing at which the video footage changed by the change section is displayed, to synchronize the timing at which the right-eye video of all the video footages is displayed and to synchronize the timing at which the left-eye video of all the video footages is displayed.

Specifically, the video control section 240 operates as follows. For example, as shown in FIG. 4, the first video 251 and the second video 252 are displayed on the screen 220. When the first video 251 is switched, the video control section 240 synchronizes the timing at which the right-eye video 251R of the switched first video 251 is displayed with the timing at which the right-eye video 252R of the second video 252 is displayed and synchronizes the timing at which the left-eye video 251L of the switched first video 251 is displayed with the timing at which the left-eye video 252L of the second video 252 is displayed. At that time, the video control section 240 delays the timing at which the switched first video 251 is displayed, to synchronize the timing at which the right-eye video 251R of the first video 251 is displayed with the timing at which the right-eye video 252R of the second video 252 is displayed and to synchronize the timing at which the left-eye video 251L of the first video 251 is displayed with the timing at which the left-eye video 252L of the second video 252 is displayed.

In addition, when the second video 252 is switched, the video control section 240 synchronizes the timing at which the right-eye video 252R of the switched second video 252 is displayed with the timing at which the right-eye video 251R of the first video 251 is displayed and synchronizes the timing at which the left-eye video 252L of the switched second video 252 is displayed with the timing at which the left-eye video 251L of the first video 251 is displayed. At that time, the video control section 240 delays the timing at which the switched second video 252 is displayed, to synchronize the timing at which the right-eye video 251R of the first video 251 is displayed with the timing at which the right-eye video 252R of the second video 252 is displayed and to synchronize the timing at which the left-eye video 251L of the first video 251 is displayed with the timing at which the left-eye video 252L of the second video 252 is displayed.

It should be noted that when the first video 251 is switched or when the second video 252 is switched, the reference signal generation section 290 may previously generate the reference signal, and the video control section 240 may adjust the delays of the right-eye video frames 251Rf and the left-eye video frames 251Lf of the first video 251 to the reference signal and may adjust the delays of the right-eye video frames 252Rf and the left-eye video frames 252Lf of the second video 252 to the reference signal.

It should be noted that the reference signal generation section 290 may generate the reference signal such that the reference signal is asynchronous with the first video frame signal having the No. 1 R video frames 251Rf and the No. 1 L video frames 251Lf and the second video frame signal having the No. 2 R video frames 252Rf and the No. 2 L video frames 252Lf, or may generate the reference signal such that the reference signal is synchronous with either the first video frame signal or the second video frame signal. Alternatively, the reference signal generation section 290 may generate the reference signal at a timing delayed based on the first video frame signal or the second video frame signal.

<Synchronously Displayed First Video 251 and Second Video 252>

Next, the synchronously displayed first video 251 and second video 252 will be described.

By performing the first frame processing or the second frame processing, the video control section 240 can synchronize a plurality of the No. 1 R video frames 251Rf and a plurality of the No. 1 L video frames 251Lf in the first video frame signal with a plurality of the No. 2 R video frames 252Rf and a plurality of the No. 2 L video frames 252Lf in the second video frame signal as shown in FIG. 9B.

When the first video 251 and the second video 252 that are displayed on the single screen 220 as shown in FIG. 4 are viewed with the shutter-type visor 100, each No. 2 R video frame 252Rf in the second video 252 is displayed during a period when each No. 1 R video frame 251Rf in the first video 251 is displayed. In addition, each No. 2 L video frame 252Lf in the second video 252 is displayed during a period when each No. 1 L video frame 25l Lf in the first video 251 is displayed. In other words, the viewer can simultaneously see the first video 251 and the second video 252 with the shutter-type visor 100.

<Conclusion>

According to the above-described configuration, since the video control section 240 simultaneously displays the first video 251 and the second video 252 in given positions on the screen 220, the viewer is allowed to simultaneously view the first video 251 and the second video 252, improving convenience.

In particular, the video control section 240 synchronizes the timing at which the right-eye video 251R of the first video 251 is displayed with the timing at which the right-eye video 252R of the second video 252 is displayed and synchronizes the timing at which the left-eye video 251L of the first video 251 is displayed with the timing at which the left-eye video 252L of the second video 252 is displayed. Thus, with regard to the first video 251 and the second video 252, the right-eye video 251R and 252R are displayed on the screen at the same timing and the left-eye video 251L and 252L are displayed on the screen at the same timing.

In other words, when the viewer watches the first video 251 and the second video 252 with the shutter-type visor 100, the viewer can simultaneously see, as proper stereoscopic video footages, these two video footages in which the timing at which the right-eye video 251R and 252R are displayed and the timing at which the left-eye video 251L and 252L are displayed are synchronized. This is because opening/closing of the shutters of the shutter-type visor 100 is synchronized with the timing at which the right-eye video 251R and 252R are displayed and the timing at which the left-eye video 251L and 252L are displayed. On the other hand, video footages in which the timing at which the right-eye video 251R and 252R are displayed and the timing at which the left-eye video 251L and 252L are displayed are not synchronized would otherwise become fragmented video footages and thus could not be watched as proper stereoscopic video footages. Therefore, in the case where the first video 251 and the second video 252 are displayed on one screen, when the viewer desires to see the first video 251 and the second video 252 as proper video footages, the timing at which the right-eye video 251R and 252R are displayed and the timing at which the left-eye video 251L and 252L are displayed only have to be synchronized. Because of this, the viewer can reliably see the first video 251 and the second video 252 simultaneously as a plurality of stereoscopic video footages.

In addition, in the video control section 240 performing the first frame processing, the reading section 281 reads the No. 1 R video frames 251Rf from the memory section 261 in synchronization with the No. 2 R video frames 252Rf and reads the No. 1 L video frames 251Lf from the memory section 261 in synchronization with the No. 2 L video frames 252Lf. Thus, even in the case where the No. 1 R video frames 251Rf and the No. 1 L video frames 251Lf in the first video frame signal are not synchronized with the No. 2 R video frames 252Rf and the No. 2 L video frames 252Lf in the second video frame signal, the No. 1 R video frames 251Rf and the No. 1 L video frames 251Lf in the first video frame signal can be synchronized with the No. 2 R video frames 252Rf and the No. 2 L video frames 252Lf in the second video frame signal. Because of this, the viewer can reliably see the first video 251 and the second video 252 simultaneously as a plurality of stereoscopic video footages.

Further, in the video control section 240 performing the second frame processing, the reading section 281 reads the No. 1 R video frames 251Rf and the No. 2 R video frames 252Rf from the memory section 260 at synchronized timing and also reads the No. 1 L video frames 251Lf and the No. 2 L video frames 252Lf from the memory section 260 at synchronized timing. Thus, even in the case where the No. 1 R video frames 251Rf and the No. 1 L video frames 251Lf in the first video frame signal are not synchronized with the No. 2 R video frames 252Rf and the No. 2 L video frames 252Lf in the second video frame signal, the No. 1 R video frames 251Rf and the No. 1 L video frames 251Lf in the first video frame signal can be synchronized with the No. 2 R video frames 252Rf and the No. 2 L video frames 252Lf in the second video frame signal. Because of this, the viewer can reliably see the first video 251 and the second video 252 simultaneously as a plurality of stereoscopic video footages.

In the present embodiment, the case has been described where the first video 251 and the second video 252 are used as a plurality of video footages. However, the same applies to the case where three or more video footages are used. When the timing at which the right-eye video 251R and 252R in at least two video footages are displayed is synchronized and the timing at which the left-eye video 251L and 251L in the at least two video footages are displayed is synchronized, the same advantageous effects can be obtained.

### Second Embodiment

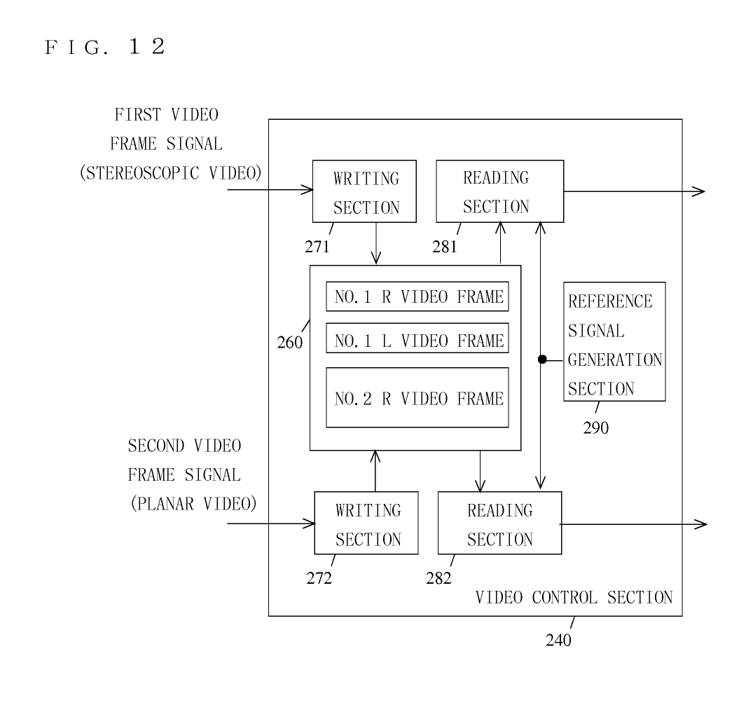

A stereoscopic video display device 200 according to a second embodiment differs from the first embodiment in that right-eye video and left-eye video can be discriminated from each other from each video frame signal by utilizing the pattern of a format for each video frame signal without using an LR discriminating signal. FIG. 11 is a diagram showing an example of formats for video frame signals used in the second embodiment. In FIG. 11, a format A shows a pattern in which right-eye video R and left-eye video L are inputted in a determined order per synchronization break. In other words, in a video frame signal inputted according to the format A, right-eye video R and left-eye video L arrive separately. A format B shows a pattern in which right-eye video R and left-eye video L are inputted without an interval unlike the format A. In other words, in a video frame signal inputted according to the format B, right-eye video R and left-eye video L consecutively arrive. The format B corresponds to, for example, a top-and-bottom method.

A format C shows a pattern in which right-eye video R and left-eye video L are inputted so as to overlap each other. In other words, in a video frame signal inputted according to the format C, right-eye video R and left-eye video L alternately arrive. The format C corresponds to, for example, a side-by-side method or a checker-pattern method. A format D shows a pattern in which a rising signal is introduced in the format A for separating right-eye video R and left-eye video L.

The stereoscopic video display device 200 according to the second embodiment can use the same configuration as that in the first embodiment. Here, the second embodiment will be described by utilizing, as an example, the stereoscopic video display device 200 shown in FIG. 1 and the video control section 240 shown in FIG. 10A. When the video control section 240 previously knows the formats for a first video frame signal and a second video frame signal, the video control section 240 can identify whether a video signal subsequent to rising or falling of a synchronization signal or a video signal is right-eye video R or left-eye video L. Thus, it is possible to discriminate between the right-eye video R and the left-eye video L by utilizing rising or falling of these signals. For example, the case where it is known that a video signal is transmitted in the format A will be described. First, the video control section 240 knows that a video signal that arrives next to an initial synchronization signal is left-eye video L. Next, the video control section 240 knows that a video signal that is inputted again after falling of the video signal is right-eye video R.

Specific flow of the processing of the video control section 240 will be described. First, the writing section 271 discriminates between the right-eye video R and the left-eye video L included in the first video frame signal from the format for the first video frame signal, stores the right-eye video R in a No. 1 R video frame 251Rf area of the memory section 260, and stores the left-eye video L in a No. 1 L video frame 251Lf area of the memory section 260. In addition, the writing section 272 discriminates between the right-eye video R and the left-eye video L included in the second video frame signal from the format for the second video frame signal, stores the right-eye video R in a No. 2 R video frame 252Rf area of the memory section 260, and stores the left-eye video L in a No. 2 L video frame 252Lf area of the memory section 260. The reading sections 281 and 282 synchronize the timing at which each right-eye video R is read from the memory section 260 and synchronize the timing at which each left-eye video L is read from the memory section 260. The other configuration of the video control section 240 operates in the same manner as in the first embodiment, and thus the description thereof is omitted. By so doing, the stereoscopic video display device 200 according to the second embodiment can discriminate between right-eye video and left-eye video from each video frame signal and can perform synchronization, by utilizing the pattern of the format for the video frame signal without using an LR discriminating signal. In other words, the stereoscopic video display device 200 according to the second embodiment can perform all the processes described in the first embodiment, even without using an LR discriminating signal.

### Third Embodiment

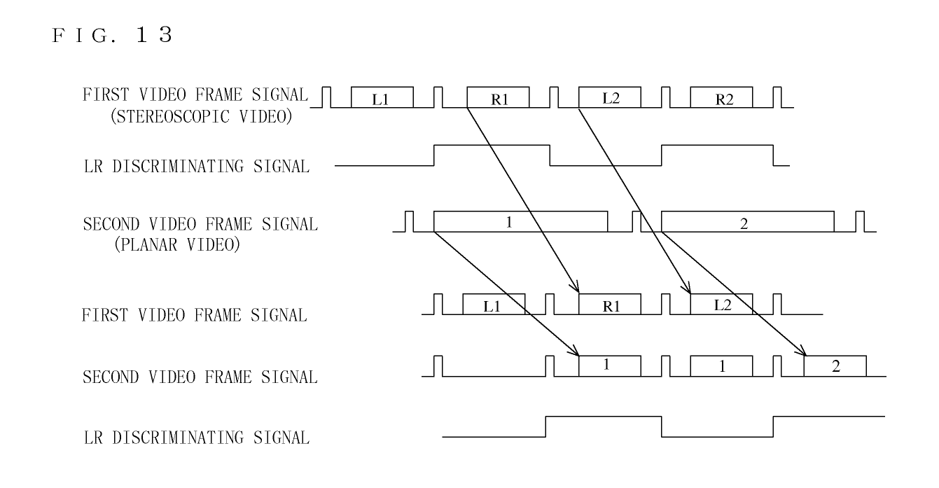

A stereoscopic video display device 200 according to a third embodiment differs from the first and second embodiments in that stereoscopic video and planar video can be simultaneously displayed on one screen. The stereoscopic video display device 200 according to the third embodiment can use the same configuration as those in the first and second embodiments, and thus the third embodiment will be described by utilizing the stereoscopic video display device 200 shown in FIG. 1. Here, as an example, the stereoscopic video display device 200 according to the third embodiment includes a video control section 240 as shown in FIG. 12. FIG. 12 is a block diagram showing an example of the configuration of the video control section 240 according to the third embodiment. FIG. 13 is a diagram showing a correspondence relationship between a first video frame signal and a second video frame signal according to the third embodiment. Referring to FIG. 13, stereoscopic video is inputted as the first video frame signal to the stereoscopic video display device 200, and planar video is inputted as the second video frame signal to the stereoscopic video display device 200. In this example, the first video frame signal is a signal of 120 Hz, and the second video frame signal is a signal of 60 Hz.

Here, in order to display the inputted second video frame signal of 60 Hz in synchronization with the inputted first video frame signal of 120 Hz, the stereoscopic video display device 200 has to generate an additional second video frame signal of 120 Hz. For this, the stereoscopic video display device 200 according to the third embodiment performs the following operations. First, in the video control section 240, the writing section 272 stores the inputted second video frame signal of 60 Hz in the memory section 260. Next, in synchronization with the right-eye video R and the left-eye video L included in the first video frame signal, the reading section 282 reads video formed on the basis of the same frame among second video frames. In other words, the video control section 240 displays the same video twice by using the second video frame signal. By so doing, video formed on the basis of the second video frames can be displayed in 120 Hz.

In addition, the video control section 240 can form pseudo stereoscopic video from the planar video and can display the stereoscopic video and the pseudo stereoscopic video in a synchronized manner. In such a case, it suffices to generate pseudo right-eye video R and pseudo left-eye video L from the second video frames by using a known pseudo stereoscopic video generation method.

Specifically, a method for displaying stereoscopic video and pseudo stereoscopic video in a synchronized manner will be described. In a first method, the reading section 282 reads the second video frame signal from the memory section 260 in synchronization with the right-eye video R or left-eye video L included in the first video frame signal and generates pseudo right-eye video R or pseudo left-eye video L from the second video frame signal. In addition, in a second method, when writing the second video frame signal into the memory section 260, the writing section 272 generates pseudo right-eye video R or pseudo left-eye video L from the second video frame signal and writes the generated video. Then, the reading section 282 reads the first video frame signal and the second video frame signal from the memory section 260 by the method described in the above embodiments, thereby enabling the stereoscopic video and the pseudo stereoscopic video to be displayed in a synchronized manner. The other configuration of the video control section 240 operates in the same manner as in the first and second embodiments, and thus the description thereof is omitted. By so doing, the stereoscopic video display device 200 according to the third embodiment can simultaneously display stereoscopic video and planar video on one screen.

It should be noted that the processing procedure executed by the stereoscopic video display device 200 described in each embodiment as one mode of the present disclosure may be realized by a CPU interpreting and executing determined program data that is stored in a storage device (ROM, RAM, hard disk, or the like) and allows the above-described processing procedure to be executed. In this case, the program data may be introduced into the storage device via a storage medium, or may be executed directly on the storage medium. Here, the storage medium refers to a semiconductor memory such as a ROM, a RAM, and a flash memory; a magnetic disk memory such as a flexible disk and a hard disk; an optical disk memory such as a CD-ROM, a DVD, and a BD; and a memory card etc. Further, the storage medium has a concept including a communication medium such as a telephone line, a transmission path, and the like.

In addition, in each embodiment as one mode of the present disclosure, each of respective functional blocks constituting the stereoscopic video display device 200 is typically realized as a program that runs on a CPU (or a processor), but some or all of the functions may be realized as an LSI, which is an integrated circuit. These functional blocks may be individually formed on a chip, or some or all of the functional blocks may be integrated on a chip. These LSIs may be referred to as ICs, system LSIs, super LSIs, or ultra LSIs depending on the degree of integration.

In addition, a technique of integrated circuit implementation is not limited to the LSI, but may be achieved by a dedicated circuit or a universal processor. An FPGA (FIELD PROGRAMMABLE GATE ARRAY) which is programmable after production of an LSI, and a reconfigurable processor in which the connection and the setting of circuit cells within the LSI are reconfigurable, may be used.

Further, needless to say, if a technique of integrated circuit implementation, which replaces the LSI, appears as a result of advancement of the semiconductor technique or another technique derived therefrom, function blocks may be integrated by using the technique. Adaptation of a bio technique could be one possibility.

### DESCRIPTION OF THE REFERENCE CHARACTERS

100 visor

200 stereoscopic video display device

210 video

210R right-eye video

210L left-eye video

220 screen

230 display panel

240 video control section

251 first video

251R right-eye video

251Rf No. 1 R video frame

251Rd video data

251L left-eye video

251Lf No. 1 L video frame

251Ld video data

252 second video

252R right-eye video

252Rf No. 2 R video frame

252Rd video data

252L left-eye video

252Lf No. 2 L video frame

252Ld video data

260, 261, 262 memory section

271, 272 writing section

281, 282 reading section

290 reference signal generation section

1. A stereoscopic video display device configured to display a plurality of stereoscopic video footages, the stereoscopic video display device comprising:
a display panel in which a screen for displaying the plurality of stereoscopic video footages is arranged; and
a video control section configured to control the display of the plurality of stereoscopic video footages; wherein
each of the plurality of stereoscopic video footages includes right-eye video and left-eye video each having parallax with respect to the other,
the video control section simultaneously displays the plurality of stereoscopic video footages in given positions on the screen, and periodically displays on the screen the right-eye video and the left-eye video of each of the plurality of stereoscopic video footages, and
the video control section synchronizes the timing at which the right-eye video of at least two stereoscopic video footages among the plurality of stereoscopic video footages is displayed, and synchronizes the timing at which the left-eye video of the at least two stereoscopic video footages is displayed.

2. The stereoscopic video display device according to claim 1, wherein the video control section synchronizes the timing at which the right-eye video of all the stereoscopic video footages among the plurality of stereoscopic video footages is displayed, and synchronizes the timing at which the left-eye video of all the stereoscopic video footages is displaying.

3. The stereoscopic video display device according to claim 1, wherein:
the plurality of stereoscopic video footages include a first video footage and a second video footage;
the right-eye video of the first video footage is formed on the basis of first R video frames and the left-eye video of the first video footage is formed on the basis of first L video frames;
the right-eye video of the second video footage is formed on the basis of second R video frames and the left-eye video of the second video footage is formed on the basis of second L video frames;
the video control section includes
a memory section configured to store the first R video frames and the first L video frames,
a writing section configured to write the first R video frames and the first L video frames into the memory section, and
a reading section configured to read the first R video frames and the first L video frames from the memory section; and
the reading section reads the first R video frames from the memory section in synchronization with the second R video frames, and reads the first L video frames from the memory section in synchronization with the second L video frames.

4. The stereoscopic video display device according to claim 3, wherein:
the memory section has an area for simultaneously storing two video frames only, including one first R video frame and one first L video frame of the first video footage; and
on the basis of a signal for discriminating between the first R video frame and the first L video frame and a signal for discriminating between the second R video frame and the second L video frame, the reading section synchronizes the timing at which the first R video frame is read from the memory section with that at which the second R video frame is read, and synchronizes the timing at which the first L video frame is read from the memory section with that at which the second L video frame is read.

5. The stereoscopic video display device according to claim 1, wherein:
the plurality of stereoscopic video footages includes a first video footage and a second video footage;
the right-eye video of the first video footage is formed on the basis of first R video frames, and the left-eye video of the first video footage is formed on the basis of first L video frames;
the right-eye video of the second video footage is formed on the basis of second R video frames, and the left-eye video of the second video footage is formed on the basis of second L video frames;
the video control section includes
a memory section configured to store the first R video frames, the first L video frames, the second R video frames, and the second L video frames,
a first writing section configured to write the first R video frames and the first L video frames into the memory section,
a second writing section configured to write the second R video frames and the second L video frames into the memory section,
a first reading section configured to read the first R video frames and the first L video frames from the memory section, and
a second reading section configured to read the second R video frames and the second L video frames from the memory section; and
the first reading section and the second reading section read the first R video frames and the second R video frames from the memory section at a synchronized timing, and read the first L video frames and the second L video frames from the memory section at a synchronized timing.

6. The stereoscopic video display device according to claim 5, wherein:
the memory section has an area for simultaneously storing two video frames only, including either a first R video frame or a first L video frame of the first video footage and either a second R video frame or a second L video frame of the second video footage; and
on the basis of a signal for discriminating between the first R video frame and the first L video frame and a signal for discriminating between the second R video frame and the second L video frame, the first reading section and the second reading section synchronize the timing at which the first R video frame and the second R video frame are read from the memory section, and synchronize the timing at which the first L video frame and the second L video frame are read from the memory section.

7. The stereoscopic video display device according to claim 5, wherein the video control section further includes a reference signal generation section configured to generate a reference signal for synchronizing the timing at which the first reading section and the second reading section read.

8. The stereoscopic video display device according to claim 1, further comprising a change section configured to change input of at least one stereoscopic video footage among the plurality of stereoscopic video footages, and input a new stereoscopic video footage; wherein
the video control section synchronizes the timing at which the right-eye video of at least two stereoscopic video footages, including the stereoscopic video footage changed by the change section and another stereoscopic video footage, is displayed and synchronizes the timing at which the left-eye video of the at least two stereoscopic video footages is displayed.

9. The stereoscopic video display device according to claim 8, wherein the video control section delays the timing at which the stereoscopic video footage changed by the change section is displayed, to synchronize the timing at which the right-eye video of all the stereoscopic video footages is displayed, and to synchronize the timing at which the left-eye video of all the stereoscopic video footages is displayed.

10. The stereoscopic video display device according to claim 3, wherein:
the first R video frames and the first L video frames of the first video footage are arranged according to a determined format in a signal inputted into the stereoscopic video display device; and
the writing section writes the first R video frames and the first L video frames into the memory section according to the determined format.

11. The stereoscopic video display device according to claim 5, wherein:
the first R video frames and the first L video frames of the first video footage are arranged according to a determined format in a signal inputted into the stereoscopic video display device;
the writing section writes the first R video frames and the first L video frames into the memory section according to the determined format;
the second R video frames and the second L video frames of the second video footage are arranged according to a determined format in a signal inputted into the stereoscopic video display device; and
the writing section writes the second R video frames and the second L video frames into the memory section according to the determined format.

12. A method performed by a stereoscopic video display device for displaying a plurality of stereoscopic video footages on a screen, wherein each of the plurality stereoscopic video footages includes right-eye video and left-eye video each having parallax with respect to the other, the method comprising:
a step of simultaneously displaying the plurality of stereoscopic video footages in given positions on the screen and periodically displaying the right-eye video and the left-eye video of each of the plurality of stereoscopic video footages; and
a step of synchronizing the timing at which the right-eye video of at least two stereoscopic video footages among the plurality of stereoscopic video footages is displayed, and synchronizing the timing at which the left-eye video of the at least two stereoscopic video footages is displayed.
